(19) United States
(12) Patent Application Publication
(10) Pub. No.: US 2026/0363319 A1
(43) Pub. Date: Nov. 19, 2026

(54) AEROSOL GENERATING DEVICE AND AEROSOL GENERATING SYSTEM

(71) Applicant: SHENZHEN FIRST UNION TECHNOLOGY CO., LTD., Shenzhen, Guangdong (CN)

(72) Inventors: Rui HONG, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/488,358

(22) PCT Filed: May 30, 2024
(86) PCT No.: PCT/CN2024/096276

§ 371 Date: Nov. 26, 2025

(30) Foreign Application Priority Data
Jun. 1, 2023 (CN) 202310648804.1

(51) Int. Cl. A24F 40/465; A24F 40/10; A24F 40/20; A24F 40/51

(52) U.S. Cl. CPC A24F 40/465; A24F 40/51; A24F 40/10; A24F 40/20

(57) ABSTRACT

An aerosol generating device and an aerosol generating system. The aerosol generating device includes a receiving cavity and an induction coil. The receiving cavity has an opening and is configured to selectively receive one of a first type of consumable including a first susceptor and a second type of consumable including a second susceptor. The receiving cavity includes a first portion and a second portion. The first portion is closer to the opening than the second portion. The first type of consumable is located in the first portion and kept away from the second portion. The second type of consumable passes through the first portion and partially extending into the second portion. The induction coil is disposed around the receiving cavity and can induce heating of the first susceptor to heat the first type of consumable or induce heating of the second susceptor to heat the second type of consumable.

### CROSS-REFERENCE TO RELATED APPLICATIONS

The present application claims priority to Chinese Patent Application No. 202310648804.1, filed with the China National Intellectual Property Administration on Jun. 1, 2023 and entitled “AEROSOL GENERATING DEVICE AND AEROSOL GENERATING SYSTEM”, which is incorporated by reference in its entirety.

### TECHNICAL FIELD

Embodiments of the present application relate to the technical field of heat-not-burn aerosol generation, and in particular, to an aerosol generating device and an aerosol generating system.

### BACKGROUND

During use of tobacco products (such as cigarettes and cigars), tobacco is burnt to generate tobacco smoke. Attempts have been made to replace these tobacco-burning products by manufacturing products that release compounds without burning.

An example of the products is a heating device that releases compounds by heating rather than burning materials. For example, the materials may be tobacco or other non-tobacco products. The non-tobacco products may or may not include nicotine. Known heating devices can only receive a specific type of tobacco or non-tobacco product, and generate a magnetic field through an induction coil, to induce heating of the susceptor to heat the received specific type of tobacco or non-tobacco product.

### SUMMARY

An embodiment of the present application provides an aerosol generating device, including: a receiving cavity having an opening; the receiving cavity being configured to selectively receive, through the opening, one of a first type of consumable including a first susceptor and a second type of consumable including a second susceptor; the receiving cavity including a first portion and a second portion, the first portion being closer to the opening than the second portion; the first type of consumable being located in the first portion and kept away from the second portion when being received in the receiving cavity; and the second type of consumable passing through the first portion and partially extending into the second portion when being received in the receiving cavity; and an induction coil, at least partially arranged around the receiving cavity; the induction coil being configured to generate a varying magnetic field, to induce heating of the first susceptor to heat the first type of consumable received in the receiving cavity, or induce heating of the second susceptor to heat the second type of consumable.

In some embodiments, the first type of consumable includes an atomizer configured to atomize a liquid substrate to generate an aerosol. The second type of consumable includes a solid aerosol generating product.

In some embodiments, the aerosol generating device further includes: a circuit, configured to control, when the first type of consumable is present in the receiving cavity, the induction coil to generate the varying magnetic field according to a first mode, and to control, when the second type of consumable is present in the receiving cavity, the induction coil to generate the varying magnetic field according to a second mode.

In some embodiments, the aerosol generating device further includes: a detection unit, configured to detect the presence of the first type of consumable or the second type of consumable received in the receiving cavity. The circuit is configured to control, based on a detection result of the detection unit, the induction coil to generate the varying magnetic field.

In some embodiments, the detection unit is configured to detect a change in at least one electrical characteristic of the induction coil caused by the reception of the first type of consumable or the second type of consumable in the receiving cavity, to determine the presence of the first type of consumable or the second type of consumable received in the receiving cavity.

In some embodiments, the aerosol generating device further includes: an airflow sensor, configured to sense an airflow passing through the receiving cavity. The circuit is configured to control, in response to a sensing result of the airflow sensor, the induction coil to generate the varying magnetic field according to the first mode; and when the second type of consumable is present in the receiving cavity, the circuit is prevented from responding to the sensing result of the airflow sensor or the airflow sensor is prevented from sensing the airflow passing through the receiving cavity.

In some embodiments, the aerosol generating device further includes: an input element, configured to be operated by a user to generate an input signal. The circuit is configured to control, in response to the input signal of the input element, the induction coil to generate the varying magnetic field according to the second mode; and when the first type of consumable is present in the receiving cavity, the circuit is prevented from responding to the input signal of the input element or the input element is prevented from generating the input signal.

In some embodiments, an inner bottom wall of the receiving cavity facing away from the opening is provided with: a first communication port and a second communication port arranged at an interval. The receiving cavity is in communication with outside air through the first communication port, such that the outside air is admitted into the receiving cavity during inhalation; and the receiving cavity is in communication with the airflow sensor through the second communication port, such that the airflow sensor is enabled to sense the airflow passing through the receiving cavity.

In some embodiments, an inner diameter of the first portion is larger than an inner diameter of the second portion.

In some embodiments, a first abutment step is defined between the first portion and the second portion; the first abutment step being configured to support, in a longitudinal direction, the first type of consumable received in the first portion.

In some embodiments, the receiving cavity further has defined therein: a second abutment step, located in the second portion; the second abutment step being configured to support, in the longitudinal direction, the second type of consumable received in the receiving cavity.

In some embodiments, the aerosol generating device further includes: a proximal end and a distal end opposite each other; the opening being close to the proximal end; and an end element, close to and defining the proximal end; the end element defining a recess located at the proximal end; the first type of consumable being at least partially located in the recess and substantially forming an airtight seal with the end element when being received in the receiving cavity, to prevent outside air from entering the receiving cavity from between the first type of consumable and the end element during inhalation.

In some embodiments, the aerosol generating device further includes: a proximal end and a distal end opposite each other; the opening being close to the proximal end; an end element, close to and defining the proximal end; and a first magnetic element, located outside the receiving cavity; the first magnetic element being configured to magnetically attract the first type of consumable when the first type of consumable is received in the receiving cavity, to partially retain the first type of consumable in engagement with the end element.

Another embodiment of the present application further provides an aerosol generating device, including: a receiving cavity, configured to selectively receive one of a first type of consumable including a first susceptor and a second type of consumable including a second susceptor; an induction coil, at least partially arranged around the receiving cavity; the induction coil being configured to generate a varying magnetic field, to induce heating of the first susceptor to heat the first type of consumable received in the receiving cavity, or induce heating of the second susceptor to heat the second type of consumable; an airflow sensor, configured to sense an airflow passing through the receiving cavity; an input element, configured to be operated by a user to generate an input signal; and a circuit, configured to control, in response to a sensing result of the airflow sensor, the induction coil to generate the varying magnetic field according to a first mode, and to control, in response to the input signal of the input element, the induction coil to generate the varying magnetic field according to a second mode; where when the first type of consumable is present in the receiving cavity, the circuit does not respond to the input signal of the input element or prevents the input element from generating the input signal; and when the second type of consumable is present in the receiving cavity, the circuit does not respond to the sensing result of the airflow sensor or prevents the airflow sensor from sensing the airflow passing through the receiving cavity.

Another embodiment of the present application further provides an aerosol generating system, including: an atomizer, configured to atomize a liquid substrate to generate an aerosol, the atomizer including a body portion and an elongated portion extending longitudinally from the body portion, the body portion being provided with a second magnetic element; and an aerosol generating device, including a receiving cavity having an opening, at least a part of the atomizer being removably received in the receiving cavity through the opening during use. The aerosol generating device includes: a housing, having a proximal end and a distal end opposite each other, the opening being close to the proximal end; the housing defining a recess located at the proximal end, a first magnetic element being arranged in the housing close to the recess, the first magnetic element being located outside the receiving cavity, and the first magnetic element attracting the second magnetic element when at least a part of the body portion of the atomizer is received in the recess, to retain the elongated portion in the receiving cavity.

In the aerosol generating device, different types of consumables are received and heated at different positions in the receiving cavity, which is advantageous for heating different types of consumables at respective suitable positions.

### BRIEF DESCRIPTION OF THE DRAWINGS

One or more embodiments are exemplarily described with reference to corresponding figures in the accompanying drawings, and the descriptions do not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generating device according to an embodiment;

FIG. 2 is a schematic cross-sectional view of the aerosol generating device in FIG. 1 from a perspective;

FIG. 3 is a schematic diagram of an aerosol generating product according to an embodiment;

FIG. 4 is a schematic diagram of an atomizer according to an embodiment;

FIG. 5 is a schematic structural diagram of the atomizer in FIG. 4 from another perspective;

FIG. 6 is a schematic cross-sectional view of the atomizer in FIG. 4 from a perspective;

FIG. 7 is a schematic diagram of an aerosol generating system formed when the aerosol generating product in FIG. 3 is received in the aerosol generating device in FIG. 1;

FIG. 8 is a schematic cross-sectional view of the aerosol generating system in FIG. 7 from a perspective;

FIG. 9 is a schematic diagram of an aerosol generating system formed when the atomizer in FIG. 4 is received in the aerosol generating device in FIG. 1;

FIG. 10 is a schematic cross-sectional view of the aerosol generating system in FIG. 9 from a perspective; and

FIG. 11 is a schematic diagram of an aerosol generating device according to another embodiment.

### DETAILED DESCRIPTION

For ease of understanding of the present application, the present application is described in more detail below with reference to the accompanying drawings and specific implementations.

An embodiment of the present application provides an aerosol generating system, to generate an aerosol. In some embodiments, the aerosol generating system may include two or more portions that are separable or replaceable relative to each other. When assembled, these portions form a complete and operational configuration of the aerosol generating system, and can respond to an operation by a user to generate the aerosol.

In an embodiment, the aerosol generating system includes an aerosol generating device. The aerosol generating device may selectively engage at least two different types of consumables for combined use and formation of the system. For example, in some embodiments, the aerosol generating device can selectively mate with either a first type of consumable or a second type of consumable, thereby forming the aerosol generating system to generate the aerosol.

In some embodiments, the aerosol generating device is configured to receive only one consumable at a time. For example, in some embodiments, the aerosol generating device can only receive either the first type of consumable or the second type of consumable at a time, and cannot receive both simultaneously.

In some embodiments, the aerosol generating device may include a detection unit. The detection unit is configured to detect presence of the first type of consumable or the second type of consumable that is inserted into and engages the aerosol generating device. Specifically, the detection unit may be configured to detect or identify a type of consumable engaging the aerosol generating device, such that operation, for example, particularly heating or power output, of the aerosol generating device is optimized to match or adapt to the corresponding first type of consumable or second type of consumable. For example, when the detection unit detects that the first type of consumable is inserted into and engages the aerosol generating device, the aerosol generating device is controlled to start operation according to a first power output mode; and when the detection unit detects that the second type of consumable is inserted into and engages the aerosol generating device, the aerosol generating device is controlled to start operation according to a second power output mode.

In some specific optional embodiments, the detection unit may include a color sensor, configured to detect a color of the consumable that engages the aerosol generating device, to determine the type of consumable.

For example, in further variant embodiments, the aerosol generating device can determine the type of consumable by detecting a physical characteristic of an electronic element in the consumable. The physical characteristic may include, for example, one or more of a resistance value, an inductance value, a voltage value, a capacitance value, and a magnetic property of the electronic element in the consumable. Therefore, in this embodiment, the detection unit may include a detection functional circuit, for example, a circuit module described below.

Alternatively, in further particular embodiments, the first type of consumable or the second type of consumable has a respective heating element. The aerosol generating device can determine the type of consumable by detecting a characteristic of the heating element in the consumable.

In some embodiments, the first type of consumable may include an atomizer that stores a liquid substrate in liquid form and causes at least one component of the liquid substrate to be vaporized to generate the aerosol. In some embodiments, the liquid substrate may include glycerol, propylene glycol, or the like, which can be heated and vaporized to generate the aerosol.

In some embodiments, the second type of consumable may include a solid aerosol generating product. By heating the solid aerosol generating product, at least one component of the solid aerosol generating product is volatilized or released to form the aerosol for inhalation. In some embodiments, the solid aerosol generating product is preferably made of a tobacco-containing material that releases volatile compounds from the substrate when heated, or may be made of a non-tobacco material that is suitable for electrically heated smoking after heating. In some specific embodiments, the aerosol generating product is preferably made of a solid substrate, which may include one or more of herbal leaves, dried flowers, herbal crops with volatile fragrance, tobacco leaves, and expanded tobacco in one or more of the following forms: powder, granules, shreds, strips, or sheets. Alternatively, the solid substrate may include additional tobacco or non-tobacco compounds with volatile fragrance that are released when the substrate is heated.

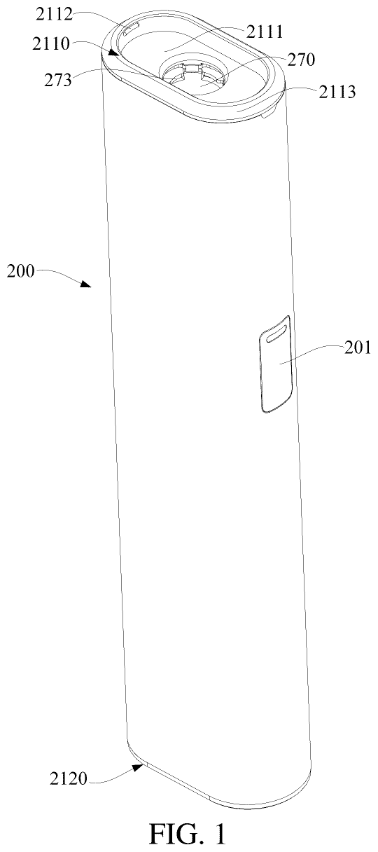

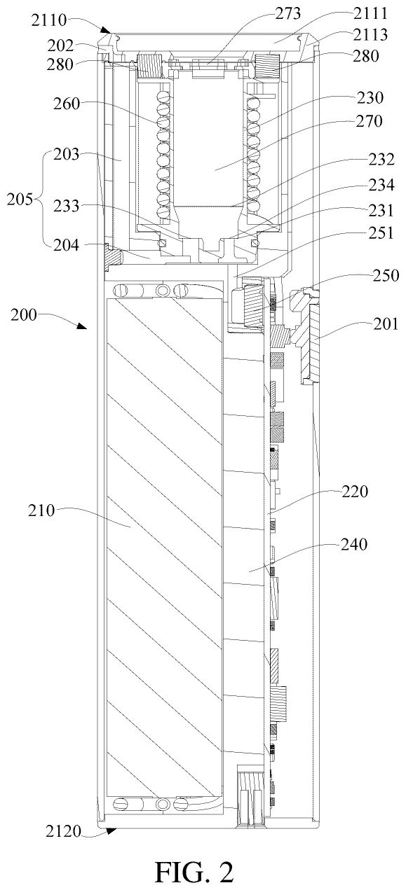

FIG. 1 and FIG. 2 are a schematic diagram of an aerosol generating device 200 according to an embodiment. In this embodiment, the aerosol generating device 200 includes:
a proximal end 2110 and a distal end 2120 opposite each other in a longitudinal direction. During use, the proximal end 2110 is an end configured to receive a consumable such as an atomizer 100 or an aerosol generating product 300.

As shown in FIG. 1 and FIG. 2, the aerosol generating device 200 further includes:
a longitudinally extending receiving cavity 270, arranged adjacent to the proximal end 2110 and extending in the longitudinal direction of the aerosol generating device 200; the receiving cavity 270 having an opening located at the proximal end 2110 in the longitudinal direction. During use, a consumable such as the atomizer 100 or the aerosol generating product 300 can be received in the receiving cavity 270 or removed from the receiving cavity 270 through the opening. In addition, one or more ridges 273 are provided at the opening of the receiving cavity 270, and are spaced apart along a circumferential direction of the receiving cavity 270. When the aerosol generating product 300 is received in the receiving cavity 270, the ridge 273 radially clamps the aerosol generating product 300, thereby retaining the aerosol generating product in the receiving cavity 270.

As shown in FIG. 1 and FIG. 2, the aerosol generating device 200 further includes:
an input element 201, configured to be operated by a user to form an input signal in response to a user operation. Then, the aerosol generating device controls heating of the aerosol generating product 300 based on the input signal of the user, In some embodiments, the input element 201 is selected from a mechanical button, a membrane button, a mechanical switch, a rotary encoder, a dial, a knob, a capacitive touch button, a resistive touch button, a joystick, a slider, a trigger button, a touch screen, and a magnetic switch.

As shown in FIG. 1 and FIG. 2, a rechargeable battery cell 210 is configured to output electric power. The battery cell 210 is arranged close to the distal end 2120.

A circuit board 220 includes, for example, a PCB or an FPC. The circuit board 220 is integrated with a circuit to control the operation of the aerosol generating device 200, and in particular, to control the electric power output by the battery cell 210. Moreover, in FIG. 1 and FIG. 2, the circuit board 220 is arranged to extend in the longitudinal direction of the aerosol generating device 200.

A support 240 is arranged to extend in the longitudinal direction of the aerosol generating device 200. In addition, the support 240 is located between the battery cell 210 and the circuit board 220. The support 240 is configured to at least partially house and retain the battery cell 210. Moreover, the circuit board 220 is securely fastened to the support 240 by a fastening member such as a screw, such that the circuit board 220 is supported and retained by the support 240.

As shown in FIG. 1 and FIG. 2, the input element 201 is electrically connected to the circuit board 220, enabling the circuit to receive the input signal generated by operating the input element 201 by the user, thereby controlling the heating of the aerosol generating product 300.

As shown in FIG. 1 and FIG. 2, the aerosol generating device 200 is further provided with:
an airflow sensor 250. When the atomizer 100 is received in the receiving cavity 270, the airflow sensor 250 is configured to sense an airflow generated by vaping the atomizer 100 by the user. The circuit board 220 controls supply of power to the atomizer 100 based on a sensing result of the airflow sensor 250, such that the atomizer 100 atomizes the liquid substrate in liquid form to generate the aerosol.

In some embodiments, the aerosol generating device 200 induces heating of the consumable by generating a varying magnetic field that penetrates the receiving cavity 270. Specifically, the consumable may be provided with an induction heating element. When received in the receiving cavity 270, the consumable can be penetrated by and heated by the varying magnetic field, thereby generating the aerosol. As shown in FIG. 1 and FIG. 2, the aerosol generating device 200 includes:
a coil support 230, surrounding and defining the receiving cavity 270; the coil support 230 being arranged close to the proximal end 2110; and
an induction coil 260, arranged around the coil support 230; the induction coil 260 being operably electrically connected to the circuit board 220, such that the varying magnetic field is generated in the receiving cavity 270 when an alternating current supplied by the circuit board 220 flows through the induction coil 260.

Specifically, the circuit of the circuit board 220 includes a capacitor, forming an LC resonant circuit with the induction coil 260. Moreover, the circuit board 220 generates, by driving the LC resonant circuit to oscillate at a predetermined frequency, the alternating current flowing through the induction coil 260, thereby enabling the induction coil 260 to generate the varying magnetic field that can penetrate the receiving cavity 270. In some embodiments, the frequency of the alternating current supplied by the circuit on the circuit board 220 to the induction coil 260 is between 80 kHz and 2000 kHz.

In some embodiments, the induction coil 260 has about 5 to 15 turns. In addition, an axial length of the induction coil 260 is about 5 mm to 15 mm.

As shown in FIG. 1 and FIG. 2, the receiving cavity 270 of the aerosol generating device 200 has defined therein:
a first abutment step 232 and a second abutment step 231, where
the first abutment step 232 is closer to the opening than the second abutment step 231; and the atomizer 100 abuts the first abutment step 232 when received in the receiving cavity 270; and
the second abutment step 231 is located at or defines an end of the receiving cavity 270 facing away from the opening; and the aerosol generating product 300 abuts the second abutment step 231 to form a stop when received in the receiving cavity 270.

As shown in FIG. 1 and FIG. 2, the aerosol generating device 200 further includes:
an air inlet 202, arranged on an outer surface of a housing of the aerosol generating device 200 for air intake during inhalation; the air inlet 202 being arranged close to the proximal end 2110.

As shown in FIG. 1 and FIG. 2, an inner bottom wall of the receiving cavity 270 is further provided with:
a first communication port 233, in fluid communication with the air inlet 202 through an air inlet channel 205, such that during inhalation, outside air entering through the air inlet 202 enters the receiving cavity 270 through the first communication port 233;
a second communication port 234, in fluid communication with the airflow sensor 250 through a sensing channel 251, such that the airflow sensor 250 can sense an airflow during inhalation by the user through the sensing channel 251 and the second communication port 234, to determine an inhalation action by the user.

In the embodiments shown in FIG. 1 and FIG. 2, the air inlet channel 205 provides a flow path for air entering from the air inlet 202 into the receiving cavity 270, and specifically includes:
a first channel portion 203, extending from the air inlet 202 toward the distal end 2120; and
a second channel portion 204, extending from the first channel portion 203 to the first communication port 233 of the receiving cavity 270 in a radial direction. In the embodiment shown in FIG. 2, the air inlet channel 205 is defined by an inner housing part located in the aerosol generating device 200.

As shown in the embodiments shown in FIG. 1 and FIG. 2, the aerosol generating device 200 further includes:
an end element 2113, close to and defining the proximal end 2110 of the housing of the aerosol generating device 200; and
a recess 2111, located on a surface of the proximal end 2110; the recess 2111 being surrounded and defined by the end element 2113; and when at least a part of the atomizer 100 is received in the receiving cavity 270, at least a part of the atomizer 100 being housed or retained in the recess 2111 defined by the end element 2113, and the atomizer 100 fitting tightly with the end element 2113, such that a substantially airtight seal is formed between the atomizer 100 and the aerosol generating device 200 at the proximal end 2110, to prevent the outside air from entering the receiving cavity 270 from between the atomizer 100 and the end element 2113 during inhalation, and ensure that the outside air can only enter the receiving cavity 270 through the air inlet 202. The end element 2113 may be made of a rigid polymeric plastic. Alternatively, in further embodiments, the end element 2113 may be made of a flexible material such as silicone, which is advantageous for facilitating the formation of an airtight seal with the atomizer 100.

In the embodiment shown in FIG. 2, the end element 2113 is assembled with other components of the aerosol generating device 200 to collectively define the housing of the aerosol generating device 200. Alternatively, in further embodiments, the end element 2113 is integrally molded with the housing of the aerosol generating device 200, or the end element 2113 forms a part of the housing of the aerosol generating device 200.

An inner side wall of the recess 2111 defined by the end element 2113 is further provided with a locking protrusion 2112 for engagement with a locking recess 114 on the atomizer 100. When at least the part of the atomizer 100 is received in the receiving cavity 270, the engagement between the locking protrusion 2112 and the locking recess 114 prevents loosening of the atomizer 100.

As shown in FIG. 1 and FIG. 2, the aerosol generating device 200 is further provided with:
a first magnetic element 280, arranged adjacent to the proximal end 2110; correspondingly, a second magnetic element 13 being arranged on the atomizer 100; the atomizer 100 being stably received in the receiving cavity 270 by magnetic attraction between the first magnetic element 280 and the second magnetic element 13 when the atomizer 100 is received in the receiving cavity 270 and abuts the proximal end 2110.

As shown in FIG. 1 and FIG. 2, the first magnetic element 280 is located outside the receiving cavity 270. In addition, the first magnetic element 280 is arranged close to an end face of the proximal end 2110. Therefore, when a first portion 121 of a second housing portion 12 of the atomizer 100 is received in the receiving cavity 270, a second portion 122 of the second housing portion 12 of the atomizer 100 remains in abutment and engagement with the end element 2113 by the magnetic attraction between the first magnetic element 280 and the second magnetic element 13.

Alternatively, in some embodiments, the first portion 121 of the second housing portion 12 of the atomizer 100 defines a longitudinal or elongated portion that extends into the receiving cavity 270, such that the elongated portion is received in the receiving cavity 270 for heating and atomization. A first housing portion 11 and the second portion 122 of the second housing portion 12 serve as a body portion exposed outside the receiving cavity 270. The second magnetic element 13 is arranged on the body portion to magnetically attract the first magnetic element 280, thereby causing the body portion exposed outside the receiving cavity 270 to abut or engage the end element 2113.

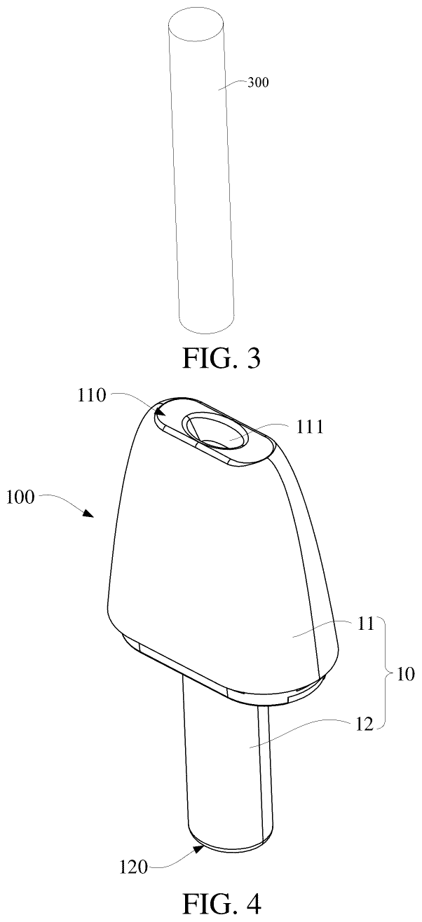

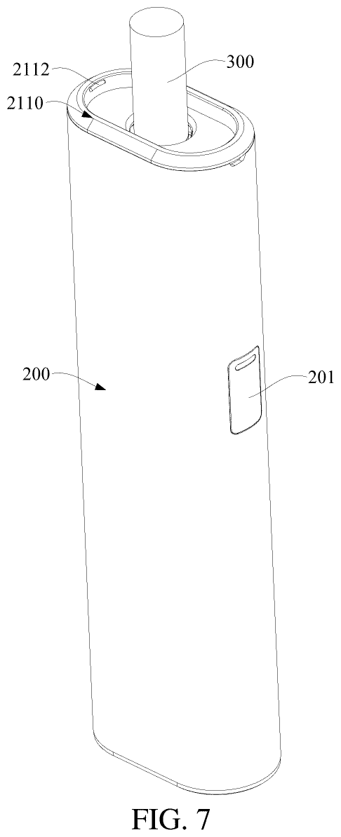

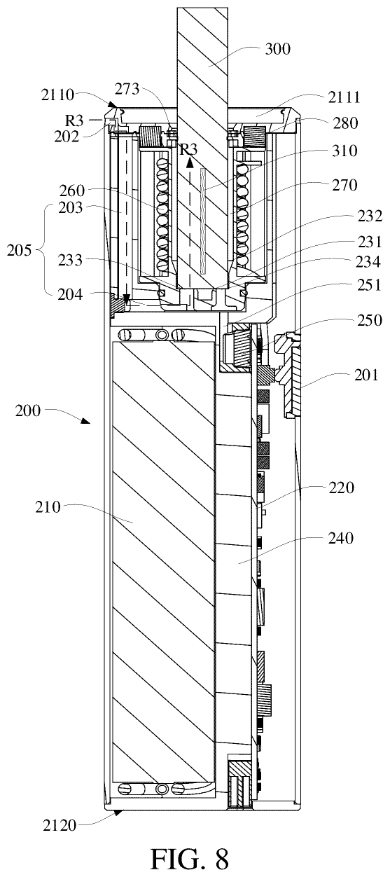

FIG. 3, FIG. 7, and FIG. 8 show schematic diagrams of an aerosol generating system formed in an embodiment when a solid aerosol generating product 300 serving as a second type of consumable is received in a receiving cavity 270 of an aerosol generating device 200. As shown in FIG. 7 and FIG. 8, in this embodiment, the aerosol generating product 300 includes:
a heating element 310, which may be a susceptor made of a susceptible metal or alloy. Moreover, the heat element 310 may be embedded in or surround a volatile component material of the aerosol generating product 300, to heat the volatile component material of the aerosol generating product 300 to generate an aerosol. When the aerosol generating product 300 is received in the receiving cavity 270, the heating element 310 is located in an induction coil 260, such that the heating element 310 is penetrated by a magnetic field generated by the induction coil 260 to heat up, thereby heating the volatile component material of the aerosol generating product 300 to generate the aerosol.

In this embodiment, a portion, for example, the volatile component material, of the aerosol generating product 300 is received in the receiving cavity 270 and heated, and another portion, for example, a filter, remains outside the aerosol generating device 200 for vaping by the user.

When the aerosol generating product 300 is received in the aerosol generating device 200, a circuit board 220 can drive, in response to an operation by a user on an input element 201, the induction coil 260 to generate the magnetic field according to a heating curve for a predetermined time, thereby heating the heating element 310 of the aerosol generating product 300. Specifically, for example, the applicant provides, in Chinese Patent Application CN112335940A and the like, various modes and content details about heating the aerosol generating product 300 according to the heating curve for the predetermined time. The full text of the foregoing documents is incorporated herein by reference.

As indicated by an arrow R3 in FIG. 7 and FIG. 8, during inhalation, outside air enters the receiving cavity 270 from an air inlet 202 through an air inlet channel 205, and passes through the aerosol generating product 300, to entrain the aerosol for delivery to the user for inhalation.

As shown in FIG. 7 and FIG. 8, the aerosol generating product 300 abuts a second abutment step 231 to form a stop. Moreover, when the aerosol generating product 300 is received in the receiving cavity 270, a gap is retained between the aerosol generating product 300 and an inner surface of the receiving cavity 270 by radial clamping of a ridge 273 and the second abutment step 231, the gap being approximately 0.5 mm to 2.0 mm.

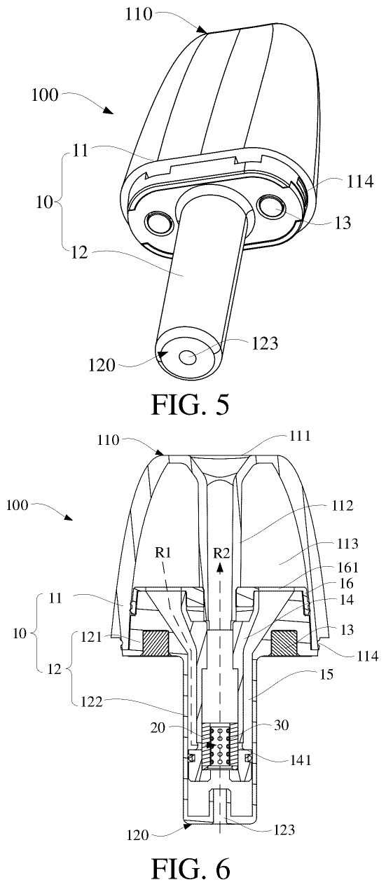

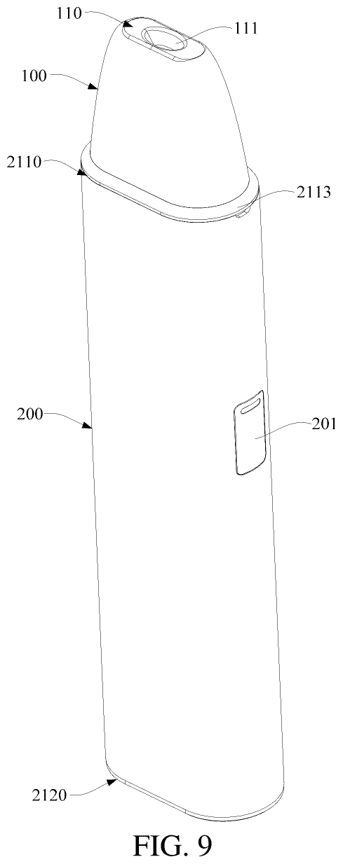

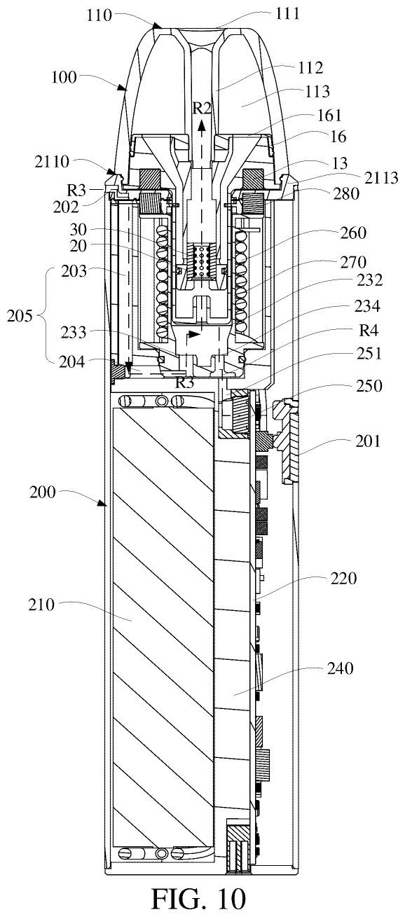

FIG. 4 to FIG. 6 show schematic diagrams of an atomizer 100 serving as a second type of consumable in an embodiment. FIG. 9 and FIG. 10 show schematic diagrams of an aerosol generating system formed when an atomizer 100 engages an aerosol generating device 200. In this embodiment, the atomizer 100 includes:
a housing 10, having a first end 110 and a second end 120 opposite each other in a longitudinal direction; the first end 110 of the housing 10 being provided with an aerosol outlet 111 to deliver an aerosol for user inhalation; and the second end 120 of the housing 10 being provided with an air inlet 123 for air intake during inhalation. The housing 10 includes a first housing portion 11 and a second housing portion 12. The first housing portion 11 is close to and defines the first end 110. The second housing portion 12 is close to and defines the second end 120.

The second housing portion 12 includes: a first portion 121 and a second portion 122 arranged sequentially in the longitudinal direction. The first portion 121 extends into the first housing portion 11 and forms a tight fit and seal with the first housing portion 11 through an interference fit. The second portion 122 is tubular and is located outside the first housing portion 11. Moreover, an outer diameter of the first portion 121 of the second housing portion 12 is greater than an outer diameter of the second portion 122 of the second housing portion 12, such that the second housing portion 12 is provided with a step between the first portion 121 and the second portion 122.

When the atomizer 100 is received in the aerosol generating device 200, the second portion 122 of the second housing portion 12 extends into a receiving cavity 270; and the second end 120 abuts a first abutment step 232 of the receiving cavity 270. Moreover, when the atomizer 100 is received in the aerosol generating device 200, the first portion 121 abuts an inner bottom wall of a recess 2111.

A second magnetic element 13 is arranged on the first portion 121 of the second housing portion 12.

An shown in FIG. 4 to FIG. 6, the atomizer 100 further includes:
an aerosol delivery tube 112, arranged in the first housing portion 11 and extending from the aerosol outlet 111 toward the second end 120, to deliver the aerosol in the atomizer 100 to the aerosol outlet 111;
a liquid storage cavity 113, defined between the aerosol delivery tube 112 and the first housing portion 11, for storing a liquid substrate;
an inner tube 14, located in the second housing portion 12; the inner tube 14 extending from the first portion 121 of the second housing portion 12 into the second portion 122 of the second housing portion 12; the inner tube 14 at least partially surrounding and engaging the aerosol delivery tube 112; a liquid guiding channel 15 being defined between the inner tube 14 and the second housing portion 12; the inner tube 14 being provided with a perforation 141 through which the liquid substrate in the liquid guiding channel 15 can enter the inner tube 14; and
an atomization assembly, located in the inner tube 14; the atomization assembly including a liquid guiding element 30 and a heating element 40, for absorbing the liquid substrate through the perforation 141 and heating and atomizing the liquid substrate to generate the aerosol; specifically, the liquid guiding element 30 communicating with the liquid guiding channel 15 through the perforation 141 to receive the liquid substrate; the heating element 40 engaging the liquid guiding element 30 being configured to be penetrated by a varying magnetic field generated by an induction coil 260 to heat up, thereby heating at least a part of the liquid substrate in the liquid guiding element 30 to generate the aerosol.

In some embodiments, the liquid guiding element 30 is a capillary or porous element having internal pores, capable of absorbing and delivering the liquid substrate by capillary action. In some embodiments, the liquid guiding element 30 may include a flexible porous capillary element such as fiber cotton or non-woven fabric. Alternatively, the liquid guiding element 30 may include a rigid porous element such as porous ceramic, porous glass, or metal foam. Moreover, in the embodiments shown in FIG. 4 to FIG. 6, the heating element 40 may be in the form of a heating track, a heating film, a heating coating, a heating mesh, or a heating coil engaging the liquid guiding element 30. Furthermore, in the embodiments shown in FIG. 4 to FIG. 6, the heating element 40 is an induction heating element, which is, for example, made of a susceptible metal or alloy that can be penetrated by the varying magnetic field to heat up. In some specific embodiments, the susceptible metal or alloy is, for example, a nickel-iron alloy, a nickel-aluminium alloy, S430 stainless steel, S420 stainless steel, or the like. When the atomizer 100 is at least partially received in or at least partially engages the receiving cavity 270, the heating element 40 is at least partially surrounded by the induction coil 260, or the heating element 40 is at least partially located in the magnetic field generated by the induction coil 260.

In the embodiments shown in FIG. 4 to FIG. 6, the liquid guiding element 30 is a hollow cylinder. The porous element 30 has an outer surface and an inner surface that are radially opposite each other. The outer surface of the liquid guiding element 30 is configured as a liquid absorbing surface to be in fluid communication with the liquid storage cavity 113, to absorb the liquid substrate, as indicated by an arrow R1 in FIG. 6. The inner surface of the liquid guiding element 30 is configured as an atomization surface; and the heating element 40 engages or is arranged adjacent to the inner surface of the liquid guiding element 30, to heat the liquid substrate to generate the aerosol, which is released from the atomization surface, and is then carried by an inhalation airflow during inhalation to the aerosol outlet 111 for inhalation, as indicated by an arrow R2 in FIG. 6.

Alternatively, in more variant embodiments, the liquid guiding element 30 may be arranged to be of a substantially sheet, plate or block shape, with two side surfaces opposite each other in a thickness direction serving as the liquid absorbing surface and the atomization surface, respectively. Alternatively, in more embodiments, the liquid guiding element 30 may have a variety of other shapes, such as an arched shape, a cup-like shape, a grooved shape, and a trapezoidal shape. Alternatively, for example, the applicant provides, in Chinese Patent Application CN215684777U, details about a shape of an arched porous element with internal channels and configurations of the porous element for absorbing and atomizing the liquid substrate. The full text of the foregoing document is incorporated herein by reference.

An shown in FIG. 4 to FIG. 6, the atomizer 100 further includes:
a flexible sealing element 16, configured in a shape of a cap; the sealing element 16 wrapping around or covering the first portion 121 of the second housing portion 12; and the sealing element 16 being at least partially located between the first portion 121 of the second housing portion 12 and the first housing portion 11, to provide a seal therebetween. Moreover, the sealing element 16 is further at least partially located between the inner tube 14 and the aerosol delivery tube 112, to provide a seal therebetween. The sealing element 16 is further provided with a relief hole 161 opposite to the liquid guiding channel 15, such that the liquid substrate in the liquid storage cavity 113 can pass through the relief hole 161 and flow into the liquid guiding channel 15.

As indicated by an arrow R3 in FIG. 10, when the user vapes the atomizer 100, outside air entering from an air inlet 202 enters the receiving cavity 270 through an air inlet channel 205, and then enters the atomizer 100, to entrain the aerosol for delivery to the aerosol outlet 111. Moreover, as shown in FIG. 10, when the user vapes the atomizer 100, an airflow sensor 250 senses, through a sensing channel 251 and a second communication port 234, an airflow passing through the atomizer 100 generated by vaping by the user.

In some embodiments, a circuit on a circuit board 220 controls, based on a sensing result of the airflow sensor 250, a power source to supply an alternating current to the induction coil 260, such that the induction coil 260 generates the varying magnetic field, to induce heating of the heating element 40 to generate the aerosol.

In some embodiments, the aerosol generating device 200 generates the varying magnetic field through the induction coil 260, to induce heating of the heating element 40/a heating element 310 in the consumable that can be penetrated by the magnetic field to heat up. In some implementations, the circuit board 220 includes a detection unit. In some embodiments, the detection unit is configured to detect the presence of the atomizer 100 or an aerosol generating product 300 that is inserted into and engages the aerosol generating device 200. Specifically, the detection unit is configured to detect or identify a type of consumable that is inserted into and engages the aerosol generating device 200, such that operation, for example, particularly heating or power output, of the aerosol generating device 200 is optimized to match or adapt to a corresponding first type of consumable or second type of consumable.

Specifically, in some embodiments, based on characteristics that the heating element 40 and the heating element 310 have different constructions and/or lengths and/or dimensions and/or shapes and/or magnetic permeabilities and/or materials and/or the like, the detection unit determines the type of consumable by detecting differences in electrical characteristic such as an equivalent inductance value, a resonant frequency and/or a quality factor (Q value) and/or a resonant voltage and/or a resonant current of the induction coil 260. Moreover, for another example, the applicant provides, in Chinese Patent Applications CN114601199A, CN112806618A and the like, details about specific electronic module composition, component arrangement, principles, and steps of the circuit on the circuit board 220 for detecting the electrical characteristics such as a resonant frequency and/or a quality factor (Q value) and/or a resonant voltage and/or a resonant current of the induction coil 260. The full text of the foregoing documents is incorporated herein by reference.

In some embodiments, when the circuit board 220 detects that the aerosol generating product 300 is received in the receiving cavity 270, the circuit board 220 supplies the alternating current to the induction coil 260 according to a first power mode in response to an input signal generated by the user by operating an input element 201, such that the induction coil 260 generates the magnetic field, to induce the heating element 310 in the aerosol generating product 300 to heat the aerosol generating product 300 according to a heating curve for a predetermined time. For example, the applicant provides, in Chinese Patent Application CN112335940A and the like, various modes and content details about heating the aerosol generating product 300 by the heating element 310 according to the heating curve for the predetermined time. The full text of the foregoing documents is incorporated herein by reference. Moreover, in some embodiments, when the circuit board 220 detects that the aerosol generating product 300 is received in the receiving cavity 270, only the circuit board 220 is allowed to respond to the input signal generated by the input element 201 to control supply of the alternating current to the induction coil 260, and the airflow sensor 250 is prevented from sensing an airflow passing through the receiving cavity 270 generated by user inhalation.

In some embodiments, when the circuit board 220 detects that the atomizer 100 is received in the receiving cavity 270, the airflow sensor 250 is allowed to sense the airflow generated by user inhalation; and when the airflow sensor 250 detects a user inhalation action, the circuit board 220 supplies the alternating current to the induction coil 260 according to a second power mode in response to the sensing result of the airflow sensor 250, such that the induction coil 260 generates the magnetic field to induce the heating of the heating element 40 in the atomizer 100. For the second power mode, for example, the applicant provides, in Chinese Patent Application CN115067564A and the like, a constant power supply mode and content details about heating and atomizing the liquid substrate. The full text of the foregoing documents is incorporated herein by reference. Alternatively, in further embodiments, electric power may be supplied according to a constant temperature heating mode.

In some embodiments, when the circuit board 220 detects that the atomizer 100 is received in the receiving cavity 270, only the circuit board 220 is allowed to respond to the sensing result of the airflow sensor 250 to control the supply of the alternating current to the induction coil 260, and the circuit board 220 is prevented from controlling, in response to the input signal generated by the user by operating the input element 201, the supply of the alternating current to the induction coil 260.

In the foregoing embodiments, the atomizer 100 and the aerosol generating product 300 have different insertion depths when being respectively received in the receiving cavity 270. Therefore, the respective heating elements 40 and 310, which have different constructions, can each be located in a suitable region and position for induced heating. Thus, suitable magnetic fields in terms of range, intensity, and distribution can be advantageously applied to the atomizer 100 and to the aerosol generating product 300, respectively.

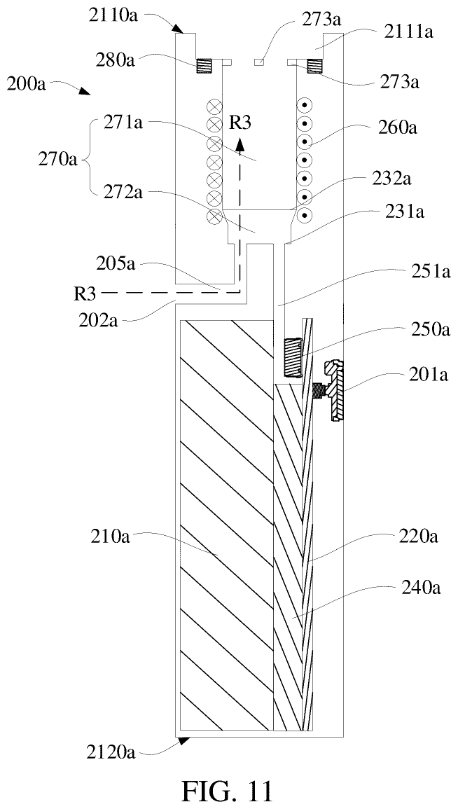

Alternatively, FIG. 11 shows a schematic diagram of an aerosol generating device 200a according to another embodiment. In the embodiment of FIG. 11, the aerosol generating device 200a includes:
a housing, having a proximal end 2110a and a distal end 2120a opposite each other in a longitudinal direction;
a battery cell 210a and a circuit board 220a close to the distal end 2120a, and a support 240a that supports and secures the battery cell 210a and the circuit board 220a;
an input element 201a, electrically connected to the circuit board 220a, to generate an input signal in response to a user operation;
a receiving cavity 270a close to the proximal end 2110a, for selectively receiving one of an atomizer 100 and an aerosol generating product 300; and
an induction coil 260a, arranged around the receiving cavity 270a; the induction coil 260a being operably electrically connected to the circuit board 220a, such that the circuit board 220a is enabled to supply an alternating current to generate a varying magnetic field in the receiving cavity 270a.

In the embodiment shown in FIG. 11, the receiving cavity 270a has an opening close to the proximal end 2110a, for removably receiving either the atomizer 100 or the aerosol generating product 300 through the opening. The receiving cavity 270a includes:
a first portion 271a and a second portion 272a arranged sequentially in the longitudinal direction, where the first portion 271a is closer to the opening;

An inner diameter or a cross-sectional area of the first portion 271a is greater than that of the second portion 272a, such that a first abutment step 232a is defined between the first portion 271a and the second portion 272a; and a side of the second portion 272a facing away from the opening is provided with a second abutment step 231a.

When being received in the receiving cavity 270a, the aerosol generating product 300 extends through the opening and abuts the second abutment step 231a to form a stop; and when being received in the receiving cavity 270a, the atomizer 100 is received only in the first portion 271a and abuts the second abutment step 231a to form a stop. In addition, one or more ridges 273a are provided at the opening of the receiving cavity 270a, and are spaced circumferentially. When the aerosol generating product 300 is received in the receiving cavity 270a, the ridge 273a radially clamps or retains the aerosol generating product 300.

In some embodiments, an outer diameter of the aerosol generating product 300 is substantially adapted to at least a part of the inner diameter of the second portion 272a of the receiving cavity 270a, and is smaller than the inner diameter of the first portion 271a of the receiving cavity 270a. Thus, when being received in the receiving cavity 270a, the aerosol generating product 300 contacts or abuts at least a part of an inner surface of the second portion 272a, while remaining out of contact with an inner surface of the first portion 271a, with a gap maintained therebetween.

Clearly, in the embodiment shown in FIG. 11, a length of the first portion 271a of the receiving cavity 270a is greater than that of the second portion 272 a. In some embodiments, the length of the first portion 271 a is approximately 8 mm to 15 mm, and the length of the second portion 272 a is approximately 3 mm to 6 mm. In addition, a length of the induction coil 260 a and/or the number of turns of the induction coil 260a surrounding the first portion 271a are greater than that surrounding the second portion 272a. The induction coil 260a has only one to two turns surrounding the second portion 272a.

In the embodiment shown in FIG. 11, the aerosol generating device 200a further includes:
a recess 2111a, located at the proximal end 2110a;
when the atomizer 100 is partially received in the receiving cavity 270a through the opening, at least a part of the atomizer 100 being housed in the recess 2111a and abutting an inner bottom wall of the recess 2111a. Moreover, the aerosol generating device 200a is further provided with:
a first magnetic element 280, configured to magnetically attract a second magnetic element 13 on the atomizer 100, such that the atomizer 100 is stably received in the receiving cavity 270a and abuts the inner bottom wall of the recess 2111a.

In the embodiment shown in FIG. 11, the aerosol generating device 200a further includes:
an airflow sensor 250a, communicating with the receiving cavity 270a through a sensing channel 251a, for sensing an airflow passing through the receiving cavity 270a during user inhalation;
an air inlet 202a, arranged on an outer surface of the housing of the aerosol generating device 200a and communicating with the receiving cavity 270a through an air inlet channel 205a, such that outside air is admitted into the receiving cavity 270a during user inhalation, as indicated by an arrow R3 in FIG. 11. Moreover, in this embodiment, the air inlet 202a is arranged, in the longitudinal direction, close to a side of the receiving cavity 270a facing away from the opening.

It should be noted that, although the specification and the accompanying drawings of the present application provide the preferred embodiments of the present application, the present application is not limited to the embodiments described in this specification. Further, a person of ordinary skill in the art may make improvements or modifications according to the above descriptions, and all of the improvements and modifications shall fall within the protection scope of the appended claims of the present application.

1. An aerosol generating device, comprising:
a receiving cavity having an opening; the receiving cavity being configured to selectively receive, through the opening, one of a first type of consumable comprising a first susceptor and a second type of consumable comprising a second susceptor; the receiving cavity comprising a first portion and a second portion, the first portion being closer to the opening than the second portion; the first type of consumable being located in the first portion and kept away from the second portion when being received in the receiving cavity; and the second type of consumable passing through the first portion and partially extending into the second portion when being received in the receiving cavity; and
an induction coil, at least partially arranged around the receiving cavity; the induction coil being configured to generate a varying magnetic field, to induce heating of the first susceptor to heat the first type of consumable received in the receiving cavity, or induce heating of the second susceptor to heat the second type of consumable.

2. The aerosol generating device according to claim 1, wherein the first type of consumable comprises an atomizer configured to atomize a liquid substrate to generate an aerosol, and the second type of consumable comprises a solid aerosol generating product.

3. The aerosol generating device according to claim 1 further comprising: a circuit, configured to control, when the first type of consumable is present in the receiving cavity, the induction coil to generate the varying magnetic field according to a first mode, and to control, when the second type of consumable is present in the receiving cavity, the induction coil to generate the varying magnetic field according to a second mode.

4. The aerosol generating device according to claim 3, further comprising:
a detection unit, configured to detect the presence of the first type of consumable or the second type of consumable received in the receiving cavity;
the circuit being configured to control, based on a detection result of the detection unit, the induction coil to generate the varying magnetic field.

5. The aerosol generating device according to claim 4, wherein the detection unit is configured to detect a change in at least one electrical characteristic of the induction coil caused by the reception of the first type of consumable or the second type of consumable in the receiving cavity, to determine the presence of the first type of consumable or the second type of consumable received in the receiving cavity.

6. The aerosol generating device according to claim 3, further comprising:
an airflow sensor, configured to sense an airflow passing through the receiving cavity;
the circuit being configured to control, in response to a sensing result of the airflow sensor, the induction coil to generate the varying magnetic field according to the first mode; and
when the second type of consumable is present in the receiving cavity, the circuit being prevented from responding to the sensing result of the airflow sensor or the airflow sensor being prevented from sensing the airflow passing through the receiving cavity.

7. The aerosol generating device according to claim 3, further comprising:
an input element, configured to be operated by a user to generate an input signal;
the circuit being configured to control, in response to the input signal of the input element, the induction coil to generate the varying magnetic field according to the second mode; and
when the first type of consumable is present in the receiving cavity, the circuit being prevented from responding to the input signal of the input element or the input element being prevented from generating the input signal.

8. The aerosol generating device according to claim 6, wherein an inner bottom wall of the receiving cavity facing away from the opening is provided with: a first communication port and a second communication port arranged at an interval, wherein
the receiving cavity is in communication with outside air through the first communication port, such that the outside air is admitted into the receiving cavity during inhalation; and the receiving cavity is in communication with the airflow sensor through the second communication port, such that the airflow sensor is enabled to sense the airflow passing through the receiving cavity.

9. The aerosol generating device according to claim 1, wherein an inner diameter of the first portion is larger than an inner diameter of the second portion.

10. The aerosol generating device according to claim 9, wherein a first abutment step is defined between the first portion and the second portion; the first abutment step being configured to support, in a longitudinal direction, the first type of consumable received in the first portion.

11. The aerosol generating device according to claim 10, wherein the receiving cavity further has defined therein:
a second abutment step, located in the second portion; the second abutment step being configured to support, in the longitudinal direction, the second type of consumable received in the receiving cavity.

12. The aerosol generating device according to claim 1, further comprising: a proximal end and a distal end opposite each other; the opening being close to the proximal end; and
an end element, close to and defining the proximal end; the end element defining a recess located at the proximal end; the first type of consumable being at least partially located in the recess and substantially forming an airtight seal with the end element when being received in the receiving cavity, to prevent outside air from entering the receiving cavity from between the first type of consumable and the end element during inhalation.

13. The aerosol generating device according to claim 1, further comprising: a proximal end and a distal end opposite each other; the opening being close to the proximal end;
an end element, close to and defining the proximal end; and
a first magnetic element, located outside the receiving cavity; the first magnetic element being configured to magnetically attract the first type of consumable when the first type of consumable is received in the receiving cavity, to partially retain the first type of consumable in engagement with the end element.

14. An aerosol generating device, comprising:
a receiving cavity, configured to selectively receive one of a first type of consumable comprising a first susceptor and a second type of consumable comprising a second susceptor;
an induction coil, at least partially arranged around the receiving cavity; the induction coil being configured to generate a varying magnetic field, to induce heating of the first susceptor to heat the first type of consumable received in the receiving cavity, or induce heating of the second susceptor to heat the second type of consumable;
an airflow sensor, configured to sense an airflow passing through the receiving cavity;
an input element, configured to be operated by a user to generate an input signal; and
a circuit, configured to control, in response to a sensing result of the airflow sensor, the induction coil to generate the varying magnetic field according to a first mode, and to control, in response to the input signal of the input element, the induction coil to generate the varying magnetic field according to a second mode;
wherein when the first type of consumable is present in the receiving cavity, the circuit does not respond to the input signal of the input element or prevents the input element from generating the input signal; and when the second type of consumable is present in the receiving cavity, the circuit does not respond to the sensing result of the airflow sensor or prevents the airflow sensor from sensing the airflow passing through the receiving cavity.

15. An aerosol generating system, comprising:
an atomizer, configured to atomize a liquid substrate to generate an aerosol, the atomizer comprising a body portion and an elongated portion extending longitudinally from the body portion, the body portion being provided with a second magnetic element; and
an aerosol generating device, comprising a receiving cavity having an opening, at least a part of the atomizer being removably received in the receiving cavity through the opening during use;
wherein the aerosol generating device comprises:
a housing, having a proximal end and a distal end opposite each other, the opening being close to the proximal end;
the housing defining a recess located at the proximal end, a first magnetic element being arranged in the housing close to the recess, the first magnetic element being located outside the receiving cavity, and the first magnetic element attracting the second magnetic element when at least a part of the body portion of the atomizer is received in the recess, to retain the elongated portion in the receiving cavity.

16. The aerosol generating device according to claim 2, further comprising: a circuit, configured to control, when the first type of consumable is present in the receiving cavity, the induction coil to generate the varying magnetic field according to a first mode, and to control, when the second type of consumable is present in the receiving cavity, the induction coil to generate the varying magnetic field according to a second mode.

17. The aerosol generating device according to claim 2, wherein an inner diameter of the first portion is larger than an inner diameter of the second portion.

18. The aerosol generating device according to claim 2, further comprising: a proximal end and a distal end opposite each other; the opening being close to the proximal end; and
an end element, close to and defining the proximal end; the end element defining a recess located at the proximal end; the first type of consumable being at least partially located in the recess and substantially forming an airtight seal with the end element when being received in the receiving cavity, to prevent outside air from entering the receiving cavity from between the first type of consumable and the end element during inhalation.

19. The aerosol generating device according to claim 2, further comprising: a proximal end and a distal end opposite each other; the opening being close to the proximal end;
an end element, close to and defining the proximal end; and
a first magnetic element, located outside the receiving cavity; the first magnetic element being configured to magnetically attract the first type of consumable when the first type of consumable is received in the receiving cavity, to partially retain the first type of consumable in engagement with the end element.
